(19) United States
(12) Patent Application Publication
(10) Pub. No.: US 2014/0291151 A1
(43) Pub. Date: Oct. 2, 2014

(54) METHOD FOR PRODUCING SOLID OXIDE FUEL CELLS HAVING A CATHODE-ELECTROLYTE-ANODE UNIT BORNE BY A METAL SUBSTRATE, AND USE OF SAID SOLID OXIDE FUEL CELLS

(71) Applicants: Mihails Kusnezoff, Dresden (DE); Nikolai Trofimenko, Dresden (DE); Egle Dietzen, Dresden (DE); Chriffe Belda, Dresden (DE)

(72) Inventors: Mihails Kusnezoff, Dresden (DE); Nikolai Trofimenko, Dresden (DE); Egle Dietzen, Dresden (DE); Chriffe Belda, Dresden (DE)

(73) Assignees: Technische Universitat Dresden, Dresden (DE); Fraunhofer-Gesellschaft zur Förderung der angewandten Forschung e.V., München (DE)

(21) Appl. No.: 13/825,656

(22) PCT Filed: Sep. 23, 2011
(86) PCT No.: PCT/DE11/01821

§ 371 Date: Oct. 7, 2013

(30) Foreign Application Priority Data
Sep. 24, 2010 (DE) 10 2010 046 146.6

(51) Int. Cl. H01M 8/10; G01N 27/409; C25B 1/04

(52) U.S. Cl. CPC H01M 8/1097; C25B 1/04; G01N 27/409
USPC 204/431; 156/280; 204/242

(57) ABSTRACT

The invention relates to a method of producing solid oxide fuel cells (SOFC) having a cathode-electrolyte-anode unit supported by a metal substrate. It is the object of the invention in this respect to provide solid oxide fuel cells which achieve an increased strength, improved temperature change resistance, a secure bonding of films forming the cathode-electrolyte-anode unit and can be produced free of distortion and reproducibly. In the method in accordance with the invention, a film forming the anode is first wet chemically applied to a surface of a porous metallic substrate as a carrier of the cathode-electrolyte-anode unit. An element which has already been sintered gas tight in advance and which forms the electrolyte is then placed on or applied a really to this film forming the anode and at a first thermal treatment up to a maximum temperature of 1250° C. the organic components contained in the film forming the anode are expelled, this film is sintered and in so doing a connection with material continuity is established between the substrate and the electrolyte. Subsequent to this, a further film forming the cathode is wet chemically applied to the electrolyte and is sintered in a further thermal treatment at temperatures beneath 1000° C. and the cathode is connected with material continuity to the electrolyte.

The invention relates to a method for producing solid oxide fuel cells (SOFCs) having a cathode-electrolyte-anode unit supported by a metal substrate, also called a CEA in the following, and to uses of same.

In addition to other cathode-electrolyte-anode units in which the mechanical strength and stability is essentially achieved with the correspondingly configured electrolyte, so-called metal supported SOFCs are known which are also called metal supported cells (MSCs). An inexpensive metallic substrate for the thin electrochemically active films of the CEA should be used in this respect. As is known, metals have more favorable mechanical properties such as a higher elongation at break and a better fracture toughness in comparison with the ceramic materials from which the electrochemical elements of the SOFCs are formed. In addition, the temperature-change resistance and the thermal conductivity are better, which is more favorable for the start-up operation and permanent operation of the SOFCs since the time required up to the achieving of the operating temperature can be shortened and damage can be avoided which occurs on temperature changes.

In this respect, it has, however, been found that problems occur due to the different thermal coefficients of expansion of the different materials which have to be used for the substrate and three electrochemical films.

In particular the ceramic material with which the electrolyte is formed creates problems in this respect.

For this reason, it was proposed in DE 10 2006 001 552 B4 to form films from the same ceramic material at a porous, plate-like substrate of an iron-chromium alloy at the two oppositely disposed surfaces in order to compensate the mechanical stresses, which result in deformations of the cathode-electrolyte-anode unit with the metallic substrate, so far that no deformation or a negligible deformation or delaminations of the electrochemically active films of the CEA can occur when the temperature changes.

This can only be achieved to a limited extent by this measure, however, since here the thickness and the strength of the metallic substrate set limits. This can thus in particular no longer be ensured reliably with a greater thickness of the porous metallic substrate and thermal stresses cannot be sufficiently compensated. Since it is, however, desired to achieve the strength of the cathode-electrolyte-anode unit substantially through the metallic substrate and also to keep further intermediate films of the CEA, in addition to the electrochemically active films, as thin as possible, this known technical solution is limited toward smaller substrate thicknesses.

Since, however, the electrolyte of an SOFC should be gas tight in as complete a manner as possible, a further problem has to be considered when the production of the electrolyte should take place via a sintering process. With the ceramic materials used for this purpose, sintering temperatures in the range of 1300° C. to 1500° C. are required, which is also the case with relatively thin electrolyte films of less than 100 μm. All other materials with which films and also the CEA are formed, however, require much lower temperatures for their sintering. As a consequence of this very high sintering temperature, the problem caused in the sintering by the different thermal coefficients of expansion and also by the shrinkage, in particular of the electrolyte film, is further exacerbated.

The crack formation in the electrolyte film, which occurs during sintering on a rigid substrate, is particularly critical.

It is therefore the object of the invention to provide solid oxide fuel cells which have an increased strength, improved resistance to temperature change, a reliable adhesion of films forming the cathode-electrolyte-anode unit, and a crack-free and gas tight electrolyte film and which can be produced free of distortion and in a reproducible manner.

In accordance with the invention, this object is achieved by a method having the features of claim 1. Uses are named in claim 10. Advantageous embodiments and further developments of the invention can be realized using features designated in subordinate claims.

In the method in accordance with the invention for producing solid oxide fuel cells having a cathode-electrolyte-anode (CEA) unit supported on a metal substrate a film forming the anode is first wet-chemically applied to a surface of a porous metal substrate, as a carrier of the cathode-electrolyte-anode unit. The metal substrate is preferably planar in this respect.

A plate-like element which has already been sintered in advance to be gas tight and which forms the electrolyte is applied a really to this film forming the anode, and subsequently to this a first heat treatment is carried out up to a maximum temperature of 1250° C. In this respect, the organic components contained in the film forming the anode (e.g. binders, plasticizers, pore builders) are first expelled, which has usually taken place up to a reaching of a temperature of around 500° C. At higher temperatures, this film is then sintered and in so doing a connection is established with material continuity between the substrate and the electrolyte. The anode and the electrolyte are then connected with one another over the full area.

Subsequent to this, a further film forming the cathode is applied wet chemically to the electrolyte and is sintered in a further heat treatment at temperatures below 1000° C. This heat treatment can be carried out on the first putting into operation, that is so-to-say in situ without an additional heat treatment step being carried out. The cathode is then connected with material continuity to the electrolyte.

Wet chemical application can be understood as processes such as screen printing, wet powder spraying, roll coating, aerosol printing or film casting. No drying of the film forming the anode is required before the application of the plate-like electrolyte which has already been sintered gas tight. A certain amount of residual viscosity even has an advantageous effect. The electrolyte can in this respect be applied to the film forming the anode using light pressure and in so doing air inclusions should be avoided.

In particular with an anode containing nickel, an intermediate film avoiding a diffusion should be wet chemically applied between the metallic substrate and the film forming the anode and should likewise be subjected to the first heat treatment. An interdiffusion of nickel into the metallic substrate material can be avoided by such an intermediate film and with a metallic substrate which is e.g. formed from an iron-chromium alloy an interdiffusion of iron and chromium into the anode material can be avoided.

The intermediate film, the film forming the anode and the film forming the cathode should each be applied with a film thickness ≦60 μm so that this film thickness is not exceeded directly after the application. These films have even further reduced film thicknesses after completion of the CEA due to the shrinkage caused in the sintering.

A sintered, preferably plate-like electrolyte should be used with a thickness ≦50 μm, preferably ≦45 μm. In this respect a density >96%, preferably >99% of the theoretical density should be achieved. The electrolyte should in this respect be completely gas tight for an oxidant or a fuel at the operating temperature of the solid oxide fuel cell.

A sintered metallic substrate which can be used with the invention should be formed from an iron-chromium alloy having at least 15% by weight, preferably at least 18% by weight chromium. It thereby has a thermal coefficient of expansion in the range 0*10⁻⁶K⁻¹ to 13.5*10⁻⁶K⁻¹. This corresponds to the thermal coefficient of expansion of the sintered electrolyte so that strains can be avoided on changing temperatures between the metallic substrate and the electrolyte and also deformations can be avoided. The porosity should amount to at least 30%, preferably 50% and particularly preferably 60%. The film thickness should lie above 200 μm up to a maximum of 1 mm.

An anode contact film can be wet chemically applied between the film forming the anode and the electrolyte and can likewise be subjected to the first heat treatment. Its film thickness should be 15 μm in the green state after the wet chemical application. This anode contact film can also be formed from the anode material, but can in this respect include a higher portion of sinter-active powdery electrolyte material having the composition Zr₁₋ₓMeₓO₂₋₆₇ . The plate-like electrolyte can then be applied to this anode contact film before the first heat treatment. The adhesion between the anode and the electrolyte as well as the redox stability and the thermal shock stability of a fuel cell can be improved by this anode contact film.

The film forming the anode can be produced from Ni/Ce_{1-x-y}MeₓMa_{y}O_{2-δ}, Ni/Zr₁₋ₓMeₓO_{2-δ} cermet with Me as a rare earth metal and Ma as a catalytically active metal or from a mixture comprising Ce_{1-x-y}MeₓMa_{y}O_{2-δ} and (La, Ca) (Ti, Cr, Ru)O₃ and/or TiC or (Y, Sr)TiO₃. Examples for suitable catalytically active metals are nickel, copper and cobalt. Suitable rare earth metals are Y, Sm, Gd, Sc, Pr, Nd or all lanthanoids.

Here, x=0 to 0.2, y=0 to 0.2 and δ=0 to 0.1.

The electrolyte can be formed from fully stabilized zirconium oxide which is stabilized with scandium, yttrium or scandium/ceria.

It is produced in a sintering process which is carried out prior to the first heat treatment.

The cathode can be formed from La_{0.6}Sr_{0.4}Fe_{0.8}Co_{3.2}0_{3-δ}, where δ=0 to 0.1.

A further intermediate film containing CeO₂ can likewise be applied wet chemically between the electrolyte and the film forming the cathode and can be subjected to the first heat treatment. This intermediate film based on doped CeO₂ prevents a formation of SrZrO₃, which can occur with an increasing ratio of Sr/La in the cathode material.

A film can be wet chemically applied to the surface of the metallic substrate disposed opposite the CEA, said film being electrically conductive and porous under reducing conditions. This film can be formed from (La, Ca)Ti, Cr, Ru)O₃ and/or TiC and/or (Y, Sr)TiO₃.

Mechanical stresses which can result in deformations of the cathode-electrolyte-anode unit with the metallic substrate can be at least reduced so much by this film that no deformation or a negligible deformation or delamination of the electrochemically active films of the CEA can be avoided at temperature changes.

The first heat treatment can advantageously be carried out in a reducing hydrogen atmosphere at temperatures beneath 1250° C. and in this respect all already applied films can be sintered together in so-called cofiring. The microstructure of the anode film is practically not altered by this relatively low maximum temperature, which in particular relates to the grain growth (coarsening of the catalytically active nickel particles). Larger porosities in the films can be formed more simply since the sintering does not result in dense sintering due to the temperature. Interactions between the film materials can be avoided or considerably reduced and a formation of pyrochlore phases can be decisively reduced or completely suppressed. Changes in the composition and the structure of the metallic substrate material can also be minimized.

A cathode-electrolyte-anode unit which is also sufficiently stable at different temperatures can be obtained using the method in accordance with the invention which is formed on a metallic substrate. All the films in this respect have good adhesion and no delaminations occur. Deformations at changing temperatures can in particular be avoided by the use of the already sintered electrolyte in the production.

The required chemical resistance can be observed on the anode side with the invention. The production can take place reproducibly in a defined geometry and with a defined microstructure and pore structure. An unwanted formation of secondary phases, in particular in the heat treatment, can be avoided.

The time up to the reaching of the required operating temperature of the SOFC in the start-up phase can be considerably reduced by the metallic substrate which makes up the largest portion of volume and mass due to its good thermal conductivity.

The energy requirement in the production can be reduced since lower temperatures are required for the sintering in the first heat treatment and smaller masses have to be sintered in the sintering of the electrolytes to be carried out separately.

Cathode-electrolyte-anode units having a metal substrate support can be produced in various dimensions, for example with a surface of 100 cm². In this respect, correspondingly dimensioned substrates and electrolytes can be used as semi-finished products.

Since metal substrates are presintered at a high temperature for reasons of long-term stability and afterward no longer show any shrinkage, a substantial problem has been solved.

It has also surprisingly been found that the cathode-electrolyte-anode unit supported by a metal substrate can also be used for the solid oxide electrolysis or as a sensor. In this respect, it can also be used as an oxygen sensor.

The invention will be explained in more detail by way of example in the following.

There is shown in:

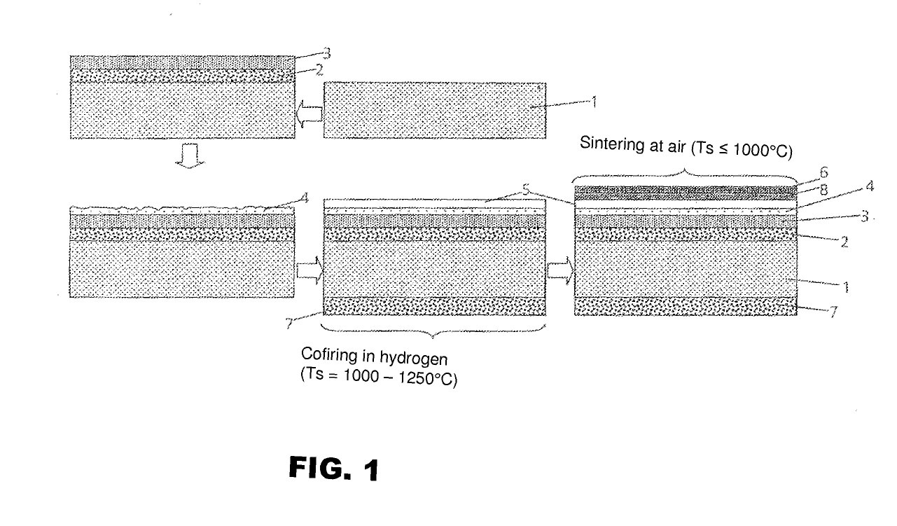

FIG. 1 the production in a plurality of stages with the layer-wise application onto a metallic substrate and the laminating on of the sintered electrolyte.

The invention should be explained by way of example in the following.

In this respect, FIG. 1 shows the production of a cathode-electrolyte-anode unit supported by a metal substrate in a plurality of steps.

An intermediate film 2 avoiding a diffusion is applied by means of screen printing to a surface of a porous metallic substrate 1 which has a thickness ≦1 mm and which is formed from an iron-chromium alloy (weight portion of chromium ≦18%). The intermediate film has a thickness ≦60 μm and comprises La_{0.47}Ca_{0.4}Cr_{0.2}Ti_{0.8}O₃. The solid portion in the paste used for the screen printing is in this respect selected so that the printed intermediate film 2 covers the pore structure of the substrate 1 and a good adhesion of the intermediate film 2 on the metallic substrate 1 is achieved after a thermal treatment, with a porous gas-permeable structure further being present.

After the drying of the intermediate film 2 at a temperature ≦200° C., a further film, which forms the anode 3, of NiO-8YSZ cermet which contains up to 50% by weight La_{0.47}Ca_{0.4}Cr_{0.2}Ti_{0.8}0₃ is applied in a pasty consistency, likewise by screen printing, with a film thickness ≦60 μm onto the intermediate film 2 and is dried. The solid portion in the paste used for the screen printing is here also selected so that a gas-permeable pore structure is present after a thermal treatment. In addition, a percolation of the predominantly electrically conductive components (Ni, La_{0.47}Ca_{0.4}Cr_{0.2}Ti_{0.8}O₃) and of the ionically conductive components(8 mol-% Y₂O₃-doped ZrO₂-8YSZ) should be achieved.

After the drying of the film forming the anode 3, a thin ≦20 μm bonding agent film is likewise applied as the anode contact film 4 by screen printing onto the film forming the anode 3. It has a smaller portion (≦40% by volume) of NiO with respect to the film forming the anode 3 and contains a sinter-active 8YSZ powder.

Subsequent to the screen printing of the film forming the anode contact film 4, the semi-finished product already sintered gas tight in advance for the electrolyte 5, which comprises 3 mol-% Y₂O₃-doped ZrO₂, is applied to this still moist and viscous anode contact film 4 over the full area. In this respect, the electrolyte 5 can be pivoted at an angle starting from an edge in a manner successively reducing the angle slowly toward the surface of the anode contact film 4 in order in particular to avoid air inclusions. The electrolyte 5 has a thickness ≦50 μm.

The still moist intermediate film 2 can be placed with the substrate 1 onto the electrolyte 5 for a better connection of film and substrate 1 which is in particular simpler to manufacture in order to keep the mechanical load of the thin electrolyte 5 as small as possible. The handing ability is thereby simplified and production faults can be better avoided.

After the application of the electrolyte 5 onto the still moist anode contact film 4, the total previously obtained multilayer structure is dried. The individual films and the electrolyte 5 then already form a sufficiently strong compound for handling.

At least one film 7 of La_{0.47}Ca_{0.4}Cr_{0.2}Ti_{0.8}O₃ is then likewise applied by screen printing to the surface of the metallic substrate still free up to then and is died. Subsequent to a thermal treatment resulting in sintering, this film 7 has a porosity sufficient for a gas passage and bonds well to the metallic substrate 1. In the thermal treatment, the film 7 can compensate the mechanical strains occurring during sintering due to the shrinkage of the individual films 2 to 4 which are arranged on the oppositely disposed side of the substrate 1.

The paste used to form the film 7 should in this respect have properties with respect to the sinter activity and the film thickness which also result in minimal deformations of the substrate 1 by the thermal treatment or on temperature changes without an electrolyte 5 already sintered in advance.

The organic components which are contained in the pastes used for the screen printing are expelled in a first thermal treatment in a hydrogen atmosphere in which heating takes place to maximum temperatures in the range of 1100° C. to 1250° C. and the components forming the films 2 to 4 and 7 sinter during a holding time in the range from 1 h to 5 h and a connection of the film structure with material continuity is achieved in cofiring.

In this thermal treatment carried out in cofiring, the conductor paths form between the electrically conductive components (iron-chromium alloy, Ni, La_{0.47}Ca_{0.4}Cr_{0.2}Ti_{0.8}O₃) and the ionically conductive components (8YSZ, 3YSZ).

After this first thermal treatment, a cathode contact film 8 of Ce_{0.8}Gd_{0.2}O₂ is applied by screen printing with a film thickness <20 μm to the side of the electrolyte 5 remote from the metallic substrate 5 and is dried. The film forming the cathode 6 of La_{0.6}Sr_{0.4}Fe_{0.8}Co_{0.2}O₃ is applied with a film thickness of ≦60 μm t this film 8, again by screen printing.

The thermal treatment resulting in the sintering of these two films 6 and 8 can take place on the first putting into operation of a solid oxide fuel cell.

The electrically conductive connection of a CEA supported by a metal substrate to an interconnector (not shown) can be achieved by a solder connection which is established at temperatures ≦1000° C.

A densification of the cathode contact film takes place to >90% of the theoretical density and a sufficiently firm connection to the porous cathode 6 is established.

1. A method for producing solid oxide fuel cells having a cathode-electrolyte-anode (CEA) unit supported by a metal substrate, wherein
a film forming the anode is wet chemically applied to a surface of a porous, metallic substrate as a carrier of the cathode-electrolyte-anode unit,
an element already sintered gas tight in advance and forming the electrolyte (5) is placed or applied a really onto this film forming the anode, and
in a first thermal treatment up to a maximum temperature of 1250° C., the organic components contained in the film forming the anode are expelled, this film is sintered and in so doing a connection with material continuity is established between the substrate and the electrolyte, and
subsequent to this, a further film forming the cathode is wet chemically applied to the electrolyte and is sintered in a further thermal treatment at temperatures beneath 1000° C. and is connected with material continuity to the electrolyte.

2. The method in accordance with claim 1, wherein the wet chemical application takes place by screen printing, wet powder spraying, aerosol printing, roll coating or film casting.

3. The method in accordance with claim 1, wherein with an anode containing nickel an intermediate film avoiding a diffusion is wet chemically applied between the substrate and the film forming the anode and is subjected to the first thermal treatment.

4. The method in accordance with claim 1, wherein the intermediate film, the film forming the anode and the film forming the cathode are each applied with a film thickness ≦60 μm, a sintered, plate-like electrolyte having a thickness ≦50 m and a density >98% of the theoretical density and a sintered metallic substrate of an iron-chromium alloy having at least 15% by weight chromium, a porosity of at least 30% and a film thickness >200 m up to a maximum of 1 mm are used.

5. The method in accordance with claim 1, wherein an anode contact film which is formed from the anode material with a higher portion contained therein of sinter-active powdery electrolyte material, having the composition Zr₁₋ₓMeₓO_{2-δ}, is applied wet chemically between the film forming the anode and the electrolyte and is subjected to the first thermal treatment.

6. The method in accordance with claim 1, wherein the film forming the anode is formed from Ni/Ce_{1-x-y}MeₓMa_{y}O_{2-δ}, Ni/Zr₁₋ₓMeₓO_{2-δ} cermet with Me as a rare earth metal and Ma as a catalytically active metal or from a mixture comprising Ce_{1-x-y}MeₓMa_{y}O_{2-δ} and (La, Ca)(Ti, Cr, Ru)O₃ and/or TiC or (Y, Sr)TiO₃ and the electrolyte is formed from Zr₁₋ₓMeₓO_{2-δ} which is stabilized by scandium, yttrium or scandium/ceria, and the cathode is formed from La_{0.6}Sr_{0.4}Fe_{0.8}Co_{0.2}0_{3-δ}.

7. The method in accordance with claim 1, wherein an intermediate film containing CeO₂ is likewise wet chemically applied between the electrolyte and the film forming the cathode and is subjected to the first thermal treatment.

8. The method in accordance with claim 1, wherein an electrolyte is used which is completely gas tight for an oxidant and a fuel at the operating temperature of the solid oxide fuel cell.

9. The method in accordance with claim 1, wherein a plate-like element sintered gas tight which forms the electrolyte and a planar metallic substrate are used.

10. Use of a cathode-electrolyte-anode unit supported by a metal substrate in accordance with claim 1 for solid oxide electrolysis or as a sensor, in particular as an oxygen sensor.
